(19) United States
(12) Patent Application Publication
(10) Pub. No.: US 2011/0191363 A1
(43) Pub. Date: Aug. 4, 2011

(54) EMBEDDED USER EXPERIENCE IN SEARCH RESULT CONTENT

(75) Inventors: Andrew Bell, Kirkland, WA (US); Dvir Horovitz, Redmond, WA (US)

(73) Assignee: Microsoft Corporation, Redmond, WA (US)

(21) Appl. No.: 12/697,065

(22) Filed: Jan. 29, 2010

(51) Int. Cl. G06F 17/30; G06F 17/21

(52) U.S. Cl. 707/767; 715/205; 707/770; 707/769; 707/E17.014; 707/E17.032; 707/E17.137

(57) ABSTRACT

Internet search queries are a powerful tool for users to discover and interact with internet content. In response to submitting a user search query, the user may be presented with search result content comprising links and descriptions of websites, images, and/or other information relevant to the user search query. Unfortunately, current search engines and/or websites do not embed user experience data (e.g., hyperlinks to additional queries, images, pop-ups, etc.) within the search result content based upon user intent. Accordingly, one or more systems and/or techniques for embedding user experience data in search result content are disclosed herein. Search result content may be received and terms (e.g., text or other data) within the search result content may be tagged based upon a user intent. User experience data may be embedded within the tagged terms. The search result content with the embedded user experience data may be presented to the user.

### BACKGROUND

Many internet users discover and interact with internet content using query searches. For example, a website may provide a user with the ability to search for internet content using a query of search words and/or phrases. The website may provide the user with content relevant to their search, such as images, hyperlinks to related websites, descriptions of related websites, additional search suggestions, etc. With the advent of mobile computing devices, users are able to utilize query searching not only from their desktop and laptop computing devices, but also from mobile computing devices (e.g., a cell phone, a PDA, etc.). Unfortunately, many mobile computing devices have limited screen space and computing power, which may reduce a user's experience when interacting with search result content. Furthermore, query searching may not provide intelligent content within descriptions of search result content to users (e.g., rich device users and/or low-tech mobile devices users). In general, mobile computing devices are limited with respect to user text input. For example, typing search queries on a small mobile device may be cumbersome for the user, due to, among other things, key size, touch screen responsiveness, etc.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for embedding user experience data in search result content is disclosed herein. It may be appreciated that user experience data, for example, may be interpreted as content (e.g., an image, a text description, a hyperlink corresponding to an additional search query suggestion, etc.) that a user may invoke to experience. Search result content of a user search query may be received as a result of a query. For example, a user may search for “red sports cars” in a searching website, such that search result content (e.g., images, text, descriptions of and links to websites, etc.) may be generated.

One or more terms (e.g., text of people, places, things, etc.) within the search result content may be tagged based upon a user intent. In one example, search result content may comprise a list of relevant websites and their respective descriptions. Terms within the website descriptions may be tagged based upon the user's intent. The user intent may be determined based upon previous user search queries, previous user search result content, previous user interaction with user search result content, previous user selection of tagged terms within user search result content, etc. It may be appreciated that the number of terms tagged may be based upon the type of device with which the user is engaged (e.g., fewer terms may be tagged for a mobile device as opposed to a desktop computing device).

User experience data may be embedded within respective tagged terms. It may be appreciated that user experience data may be selected based upon the type of device with which the user is engaged. In one example, a hyperlink of an additional search query suggestion (e.g., user experience data comprising a full search query of the tagged term) may be embedded within the tagged term. In response to user interaction with the hyperlink of the additional search query suggestion, the user may be presented with a robust experience by refreshing the search result content with new search result content from the additional search query, which may be advantageous to present to a user of a rich device, for example.

In another example a hyperlink of adjunct call data (e.g., a partial search term query) may be embedded within a tagged term. In response to user interaction with hyperlink of the adjunct call data, the user may be presented with additional user experience data without refreshing the current search result content, which may be advantageous to a user of a mobile device, for example, due to limitations of the mobile device. For example, a user may be presented with an initial search result page comprising an embedded hyperlink of adjunct call data through a browser. Upon user interaction with the hyperlink, a request to a server for additional user experience data may be made based upon the adjunct call data. The server may return the additional user experience data to the browser. The browser may present the additional user experience data to the user without refreshing the initial search result page.

In yet another example, user experience data may comprise pop-ups comprising images and/or text with which a user may interact. The pop-up data may be directly embedded within the tagged terms of an initial search result page. This allows the user to be presented with pop-ups without retrieving additional data from a server and/or without refreshing the initial search result page. It may be appreciated that terms may be tagged within user experience data. It may be appreciated that the systems and techniques described herein are not limited to internet search result content, but may apply to a wide variety of search result content, such as database queries and/or other data searches, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of embedding user experience data in search result content.

FIG. 2 is a component block diagram illustrating an exemplary system for embedding user experience data in search result content.

FIG. 3 is a component block diagram illustrating an exemplary system for providing additional data to a user based upon user interaction with embedded user experience data.

FIG. 4 is an illustration of an example of search result content with embedded user experience data.

FIG. 5 is an illustration of an example of search result content with embedded user experience data.

FIG. 6 is an illustration of an example of search result content with embedded user experience data.

FIG. 7 is an illustration of an example of search result content with embedded user experience data before user interaction and additional search result content after user interaction.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Today, internet searching websites and web services provide internet users with search result content tailored to their user search queries. Users may engage in content searching through rich devices, such as desktop personal computing devices, and mobile devices, such as cell phones. It may be appreciated that a rich device may be interpreted as a desktop personal computing device, a laptop, a netbook, a high-tech smart phone, a mobile device supporting an internet browser application with full scripting support, and/or one or more other computer devices that provide robust (online) experiences. It may be appreciated that mobile devices may comprise low-tech cell phones and/or one or more other mobile devices that do not provide robust (online) experiences (e.g., a mobile device supporting an internet browser application without full scripting support). It may be advantageous for search result content providers to provide the user with additional information within the search result content. That is, a user may have a more robust experience when provided with additional search queries related to the original search result content and the user's intent. For example, a user may search for “sports cars”. The search result content may provide the user with images of sports cars, hyperlinks to and descriptions of websites relating to sports cars, and/or other relevant information. Within the descriptions of the websites, additional relevant terms may be discovered. For example, a term “sport tires” or a term “upcoming race in North Carolina” may be of interest to the user. Thus, it may be advantageous to inform the user of these terms and provide a technique for the user to interact with these additional terms.

Currently, user experience data associated with particular terms within search result content is not embedded within the search result content (e.g., currently, hyperlinks are not embedded within terms of a description of a website) and/or provided to the user. One current solution is to provide additional content outside of the search result content (e.g., at the bottom of the search result content as opposed to embedded within descriptions of websites). Unfortunately, if additional content is, for example, embedded at the bottom of the search results, then a user may not notice the additional content (e.g., the user never scrolls down far enough to notice the additional content). This issue may arise in mobile devices where interaction through a mobile device's small screen may be cumbersome. For example, user text input to perform a search may be burdensome because of the size of the mobile device, and more particularly the size of input keys, for example.

Accordingly, one or more systems and/or techniques for embedding user experience data in search result content are provided herein. Terms within search result content may be embedded with user experience data based upon user intent. In this way, a user may view the text of the search result content, visibly see tagged terms (e.g., a tagged term may be visible as a hyperlink), and may interact with user experience data embedded within the tagged term. In one example, an additional query of a tagged term may be provided to a user when the user clicks the tagged term. In another example, a pop-up of additional information related to a tagged term may be provided to a user when the user clicks the tagged term. In this way, a user's experience may be enhanced by providing rich information about other relevant items (e.g., people, places, things, etc.) found within the search result content to the user. The additional query suggestions and relevant information allow the user to perform new search queries without the burden of typing additional and/or supplemental search queries into the mobile device.

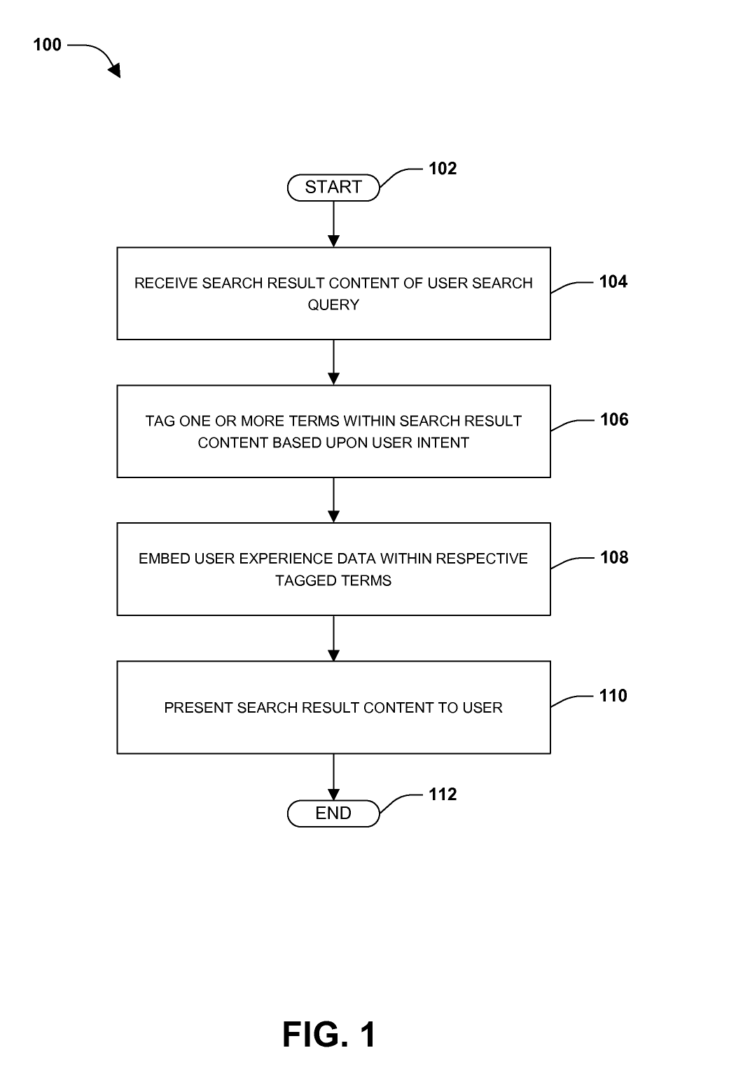

One embodiment of embedding user experience data in search result content is illustrated by an exemplary method 100 in FIG. 1. At 102, the method begins. At 104, search result content of a user search query is received. For example, a user may enter a query “local homes for sale” in a search engine website. The search engine website may generate search result content based upon the query “local homes for sale”. The search result content may, for example, comprise links to and descriptions of relevant websites, images, and other information, which may be displayed to the user as a webpage within the search engine website.

At 106, one or more terms within the search result content may be tagged based upon user intent. That is, the search result content may be scanned to find terms (e.g., keywords) relevant to the user's intention. The user intent may be determined based upon previous user search queries of the current user and/or other users, user search result content of the current user and/or other users, user interaction with user search result content of the current user and/or other users, and/or user selection of tagged terms within user search result content of the current user and/or other users. This allows for multiple factors to be considered when determining user intent. It may be appreciated that rich computing devices may have more processing power, resources, and/or display size than mobile devices, thus the number of terms tagged within the search result content may be adjusted based upon the type of device with which the user is engaged (e.g., less terms may be tagged when a mobile device is used because of the small screen). It may be appreciated that in one example, a search platform server may scan the search result content and tag query suggestions (terms) based upon user intent.

At 108, user experience data may be embedded within the tagged terms. It may be appreciated that user experience data may be hyperlinks comprising adjunct call data and/or additional search query suggestions; pop-ups comprising an image and/or text; images; query suggestions; text; and/or other additional relevant information. It may be appreciated that the user experience data is embedded into the content of the search result content, such that a user may interact with the user experience data within the search result content (e.g., a visible hyperlink embedded in a keyword of a description of a website within search result content). That is, a hyperlink relating to an additional search query, for example, may be embedded within the text of the search result content such that a user may invoke the hyperlink to perform a new search query based upon the additional search query.

In one example, a link comprising data relating to the tagged term (e.g., textual description of the tagged term, a hyperlink to a search query related to the tagged term, etc.) may be embedded within a tagged term. In one implementation, the link may be implemented as a pop-up that may display the data related to the tagged term. In another implementation, the link may be implemented as a full search term query. That is, user interaction with the full search term query (e.g., a click on a link of a keyword within the text of search result content) may be received. Additional user experience data may be retrieved, for example from backend servers, based upon the user interaction with the full search term query. The additional user experience data may be presented to the user as new search result content. It may be appreciated that a webpage that is to display the new search result content may be refreshed. Providing a refreshed page of new additional data may be advantageous for a rich computing device to enhance the user's experience, whereas a refresh of the webpage may be burdensome to a mobile device.

In yet another implementation, the link may be implemented as a partial search term query. That is, user interaction with the partial search term query (e.g., a click on a link of a keyword within the text of search result content) may be received. In one example, the partial search term query may comprise adjunct call data relating to the tagged term. Upon receiving user interaction with the partial search term query, additional user experience data may be retrieved, for example from one or more backend servers. The additional user experience data may be presented to the user without refreshing the original search result content (e.g., a pop-up comprising the additional user experience data may be presented without refreshing a webpage displaying the original search result content).

It may be appreciated that not refreshing the presented search result content may be advantageous to mobile device users because of the limited resources of a mobile device. Otherwise, a full refresh may overburden and/or reduce the performance of the mobile device. Additionally, user experience data may be selected based upon the type of device with which the user is engaged (e.g., robust user experience data for rich devices and minimalistic user experience data for mobile devices). At 110, the search result content may be presented to the user. For example, the search result content may be presented through a webpage with which the user is engaged. At 112, the method ends.

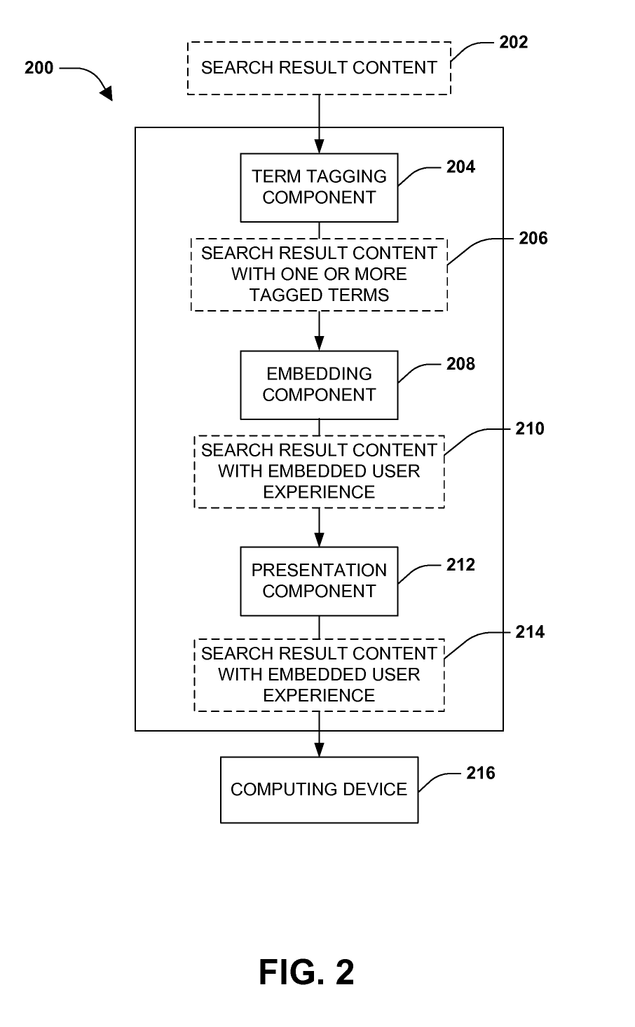

FIG. 2 illustrates an example of a system 200 configured for embedding user experience data in search result content 202. The system 200 may comprise a term tagging component 204, an embedding component 208, and/or a presentation component 212. The term tagging component 204 may be configured to receive search result content 202 of a user search query. The term tagging component 204 may be configured to tag one or more terms within the search result content 202 based upon a user intent, thus generating a search result content with one or more tagged terms 206. The term tagging component may be configured to determine the user intent based upon previous user search queries, user search result content, user interaction with user search result content, user selection of tagged terms within user search result content, etc.

The embedding component 208 may be configured to embed user experience data within respective tagged terms (e.g., the search result content with one or more tagged terms 206), thus generating a search result content with embedded user experience 210. In one example, the user experience data may be a link (e.g., a hyperlink) corresponding to pop-up data related to the tagged term. In another example, the user experience data may be a link comprising metadata instructions of an adjunct call. That is, additional data may be retrieved using the adjunct call and presented when a user invokes the link. The adjunct call allows for additional data to be retrieved and presented without refreshing a webpage displaying search result content comprising the link. It may be appreciated that an adjunct call may be advantageous for a mobile device user because it allows for additional information to be presented to the user without a full refresh of the search result content, which may be resource intensive. In other examples, the user experience data may be a pop-up comprising an image, a pop-up comprising text, etc.

The presentation component 212 may be configured to present search result content to a user. That is, search result content with embedded user experience 214 may be presented to a user through a computing device 216 with which the user is engaged. For example, the presentation component 212 may present the search result content with embedded user experience 214 through a web browser running on the computing device 216.

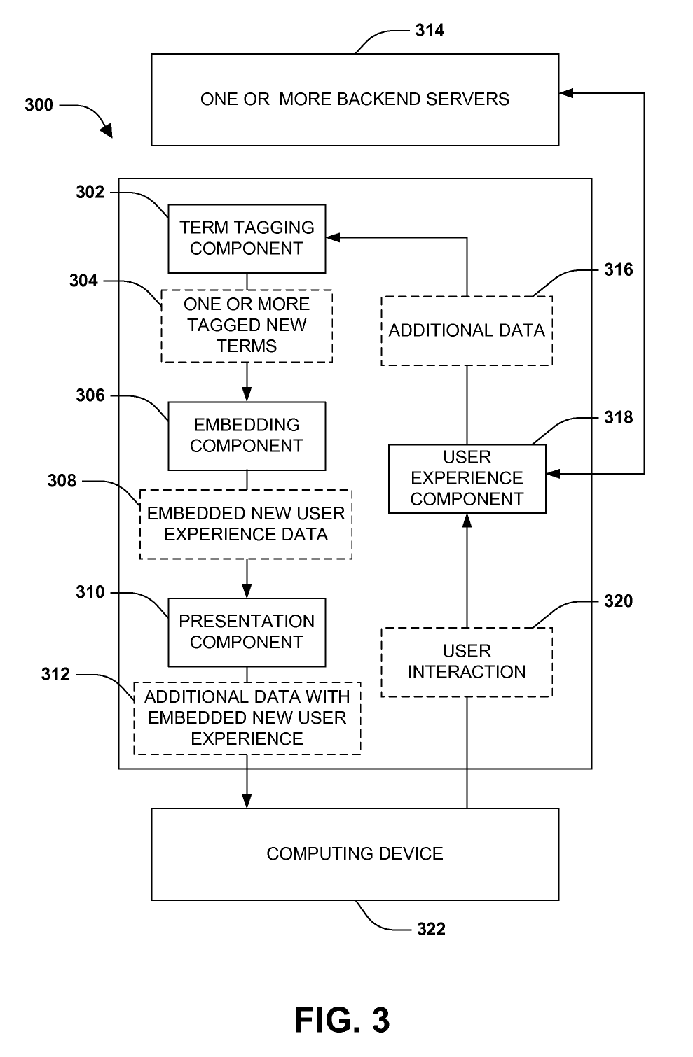

FIG. 3 illustrates an example of a system 300 configured for providing additional data to a user based upon user interaction with embedded user experience data. System 300 may comprise a term tagging component 302, an embedding component 306, a presentation component 310, and a user experience component 318. It may be appreciated that a user may be presented, for example through a computing device 322, with search result content comprising embedded user experience data. That is, search result content (e.g., a webpage comprising images, text, and hyperlinks with descriptions of other relevant websites) comprising embedded user experience data (e.g., hyperlinks of additional search queries embedded in the text of relevant website descriptions) may be presented to the user in response to a user search query. It may be appreciated that the user may interact with the embedded user experience data (e.g., a user may click a hyperlink embedded in a tagged term to invoke a new search related to the term or display a pop-up of additional data relevant to the tagged term) using the computing device 322.

The user experience component 318 may be configured to receive user interaction 320 with embedded user experience data of a tagged term. In one example, a frontend rendering server may receive the user interaction 320 from the computing device 322. The user experience component 318 may be configured to retrieve additional data 316 from one or more backend servers 314 regarding the tagged term (e.g., the term embedded with the user experience data) based upon the user interaction 320. It may be appreciated that in one example, the additional data 316 may comprise at least one of: new search result content relating to the tagged term, textual information of the tagged term (e.g., a pop-up), images (e.g., a pop-up), and/or other additional data relating to the user interaction 320 with the embedded user experience data.

In one example, the additional data 316 may be presented to the user without additional processing. That is, the additional data 316 may be presented to the user without embedding new user experience. In another example, the additional data 316 may be embedded with new user experience based upon a new user intent and new tagged terms. The term tagging component 302 may be configured to tag one or more new terms within the additional data based upon a new user intent, thus generating one or more tagged new terms 304 within the additional data 316. It may be appreciated that the term tagging component 302 may determine the new user intent based upon the user interaction 320 and/or considerations (e.g., previous user search queries, user search result content, user interaction with user search result content, user selection of tagged terms within user search result content, etc.). The embedding component 306 may be configured to embed new user experience data within the one or more tagged new terms 304 of the additional data 316, thus generating embedded new user experience data 308. The presentation component 310 may be configured to present the additional data with the embedded new user experience 312 to the user through a pop-up, additional search result content, etc.

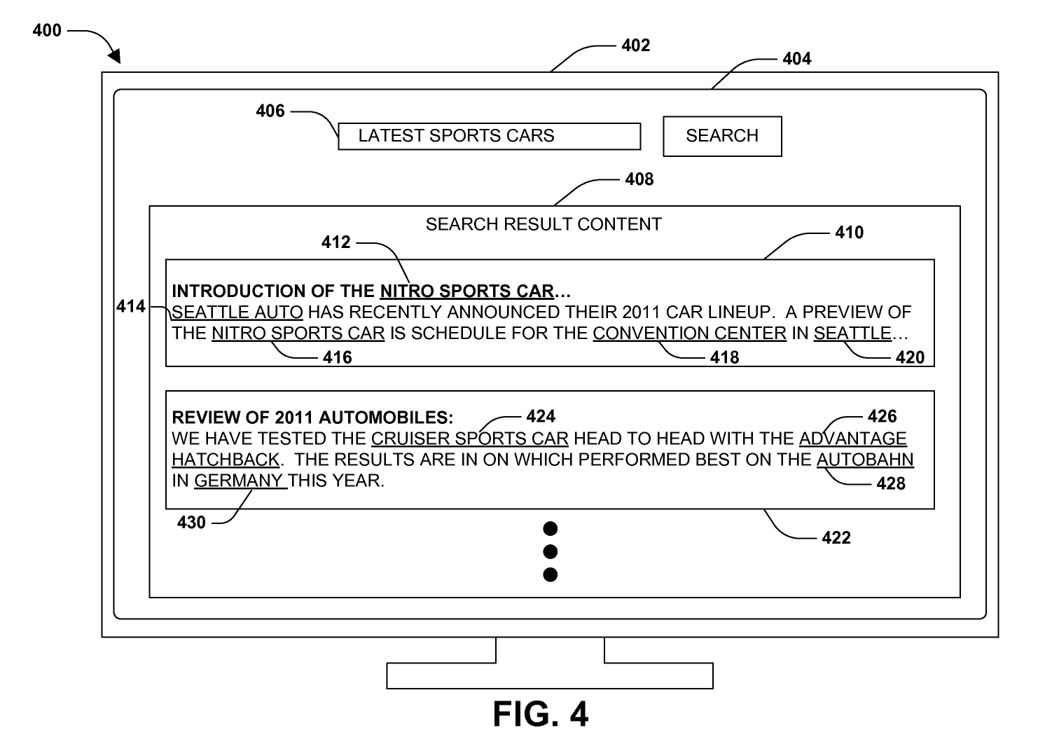

FIG. 4 illustrates an example 400 of search result content 408 with embedded user experience data. A user may utilize a rich computing device 402 to interact with a searching website 404. The user may, for example, submit a query “latest sports cars” 406 to the searching website 404. Based upon the query “latest sports cars” 406, search result content 408 with embedded user experience data may be generated and/or presented to the user. The search result content 408 may comprise a first website link and description 410, a second website link and description 422, and/or other data relevant to the query “latest sports cars” 406.

In one example of embedding the search result content 408 with user experience data, the search result content 408 may be received, for example, by a term tagging component. One or more terms within the search result content 408 may be tagged based upon a user intent, which may be determined by the term tagging component. In one example, a broad user intent may be determined as relating to sports car models, locations associated with sports cars, auto makers, etc. In this example, a first term “Nitro Sports Car” 412, a second term “Seattle Auto” 414, a third term “Nitro Sports Car” 416 (it may be appreciated that a duplicate term may or may not be tagged and/or embedded with user experience data), a fourth term “convention center” 418, and a fifth term “Seattle” 420 may be tagged within the first website link and description 410 based upon the broad user intent. A sixth term “Cruiser Sports Car” 424, a seventh term “Advantage Hatchback” 426, an eighth term “Autobahn” 428, and a ninth term “Germany” 430 may be tagged within the second website link and description 422 based upon the broad user intent.

That tagged terms within the first website link and description 410 and the second website link and description 422 may be embedded with user experience data. For example, the first term “Nitro Sports Car” 412 may be embedded with a hyperlink linking to a full search query relating to Nitro Sports Cars. The second term “Seattle Auto” 414 may be embedded with a pop-up comprising stock information of the automobile company Seattle Auto. The fifth term “Seattle” 420 may be embedded a link comprising adjunct call data, which when invoked, may be used to provide additional information (e.g., tourist spots in Seattle) to the user within the searching website 404 without refreshing the searching website 404 and/or the search result content 408. It may be appreciated that the embedded user experience data is not limited to the examples provided, but may take advantage of various technique for presenting a user with additional data.

In another example, a narrow user intent may be determined as relating strictly to sports car makers and sports car models. It may be appreciated that, for example, a different set of terms (e.g., fewer terms) within the search result content 408 may be tagged in comparison with tagging terms using the broad user intent. For example, the first term “Nitro Sports Car” 412, the second term “Seattle Auto” 414, and the third term “Nitro Sports Car” 416 may be tagged within the first website link and description 410 based upon the narrow user intent. However, the fourth term “convention center” 418 and the fifth term “Seattle” 420 may not be tagged within the first website link and description 410 because they do not fit within the narrow user intent. The sixth term “Cruiser Sports Car” 424 and the seventh term “Advantage Hatchback” 426 may be tagged within the second website link and description 422. However, the eighth term “Autobahn” 428, and the ninth term “Germany” 430 may not be tagged within the second website link and description 422 because they do not fit within the narrow user intent. The tagged terms may be embedded with user experience data. The search result content 408 with the embedded user experience data may be presented to the user through the searching website 404 on the rich device 402.

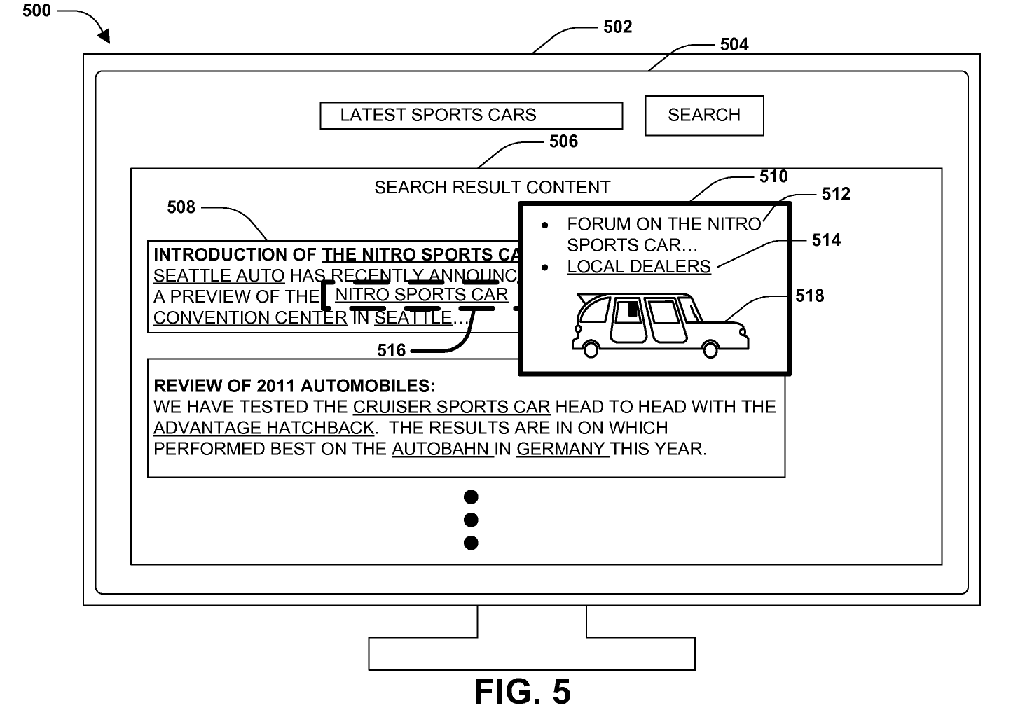

FIG. 5 illustrates an example 500 of search result content 506 with embedded user experience data. A user may utilize a rich computing device 502 to interact with a searching website 504. The user may, for example, submit a query “latest sports cars” to the searching website 504. Based upon the query “latest sports cars”, search result content 506 with embedded user experience data may be generated and/or presented to the user. The search result content 506 may comprise a first website link and description 508, a second website link and description, and/or other data relevant to the query “latest sports cars”.

The first website link and description 508 may comprise one or more tagged terms having embedded user experience data. For example, a third term “Nitro Sports Car” 516 may be embedded with a link to a pop-up 510 (user experience data). The pop-up 510 may comprise a first textual description 512, a second textual description 514 with an embedded hyperlink linking to local car dealers, and a car image 518. It may be appreciated that the link to the pop-up 510 and the pop-up 510, along with the first textual description 512, the second textual description 514 with the embedded hyperlink linking to local car dealers (e.g., a tagged term within the user experience data, the tagged term comprising user experience data), and the car image 518 may be interpreted as user experience data. It may be appreciated that terms within user experience data may be tagged and/or embedded with additional user experience data.

In one example, within the search result content 506, a user may click the link embedded within the third term “Nitro Sports Car” 516, which may be interpreted as user interaction with embedded user experience data of a tagged term. In response to the user interaction, the pop-up 510 may be presented to the user. It may be appreciated that the car image 518 is presented to the user because the rich computing device 502 may have resources and processing power capable of handling such rich user experience data as opposed to plain text. It may be appreciated that in the example 500, the pop-up 510 and the data comprised within may be embedded within the search result content 506. It may be appreciated that in another example, user experience data may link to data external to the search result content 506, such as a full search query that may be executed on one or more backend servers.

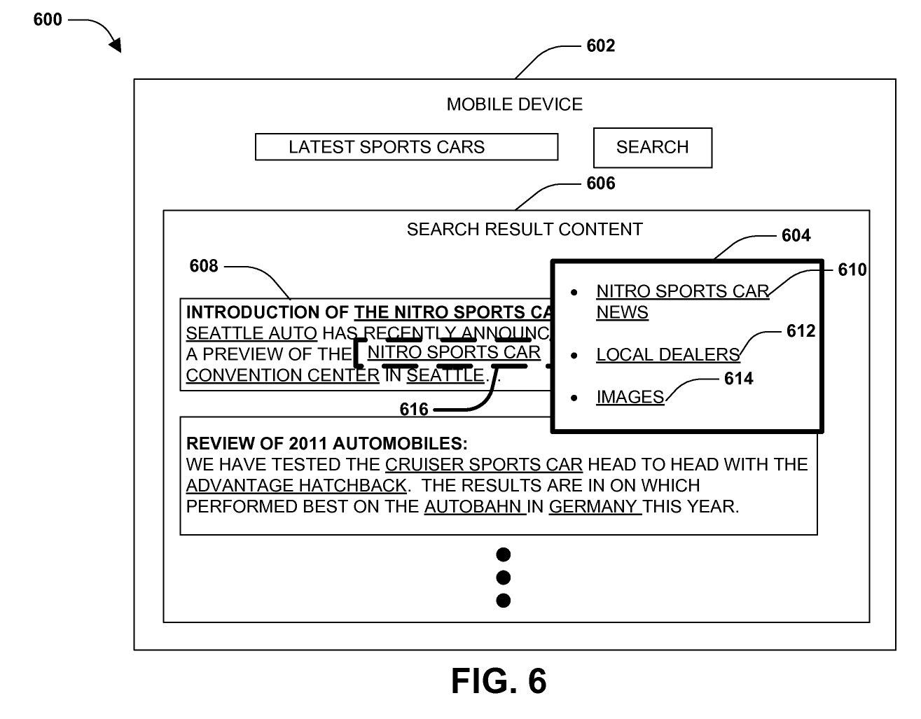

FIG. 6 illustrates an example 600 of search result content 606 with embedded user experience data. A user may utilize a mobile device 602 to interact with a searching website. The user may, for example, submit a query “latest sports cars” to the searching website. Based upon the query “latest sports cars”, search result content 606 with embedded user experience data may be generated and/or presented to the user. The search result content 606 may comprise a first website link and description 608, a second website link and description, and/or other data relevant to the query “latest sports cars”.

The first website link and description 608 may comprise one or more tagged terms having embedded user experience data. For example, a third term “Nitro Sports Car” 616 may be embedded with a link to a pop-up 604 (user experience data). It may be appreciated that the user may invoke the link (e.g., click the link) to display the pop-up 604. The pop-up 604 may comprise a first textual description 610 with an embedded hyperlink linking to news search results, a second textual description 612 with an embedded hyperlink linking to local car dealers, and third textual description 614 with an embedded hyperlink linking to an image query relating to Nitro Sports Cars.

It may be appreciated that the embedded user experience data (e.g., the first textual description 610, the second textual description 612, and the third textual description 614) may comprise minimal data (e.g., a hyperlink to additional data not comprised within the search result content 606, as opposed to images embedded within the user experience data of the search result content 606) because the user is engaged with the searching website through a mobile device 602 (e.g., a device having low bandwidth, processing power, and/or screen size as opposed to a desktop computing device). The user may invoke the hyperlinks to receive additional information related to the tagged terms (e.g., news, dealer locations, images, etc.). It may be appreciated that the embedded user experience data (e.g., the pop-up 604) may comprise more robust data if the user was engaged with the searching website through a rich device.

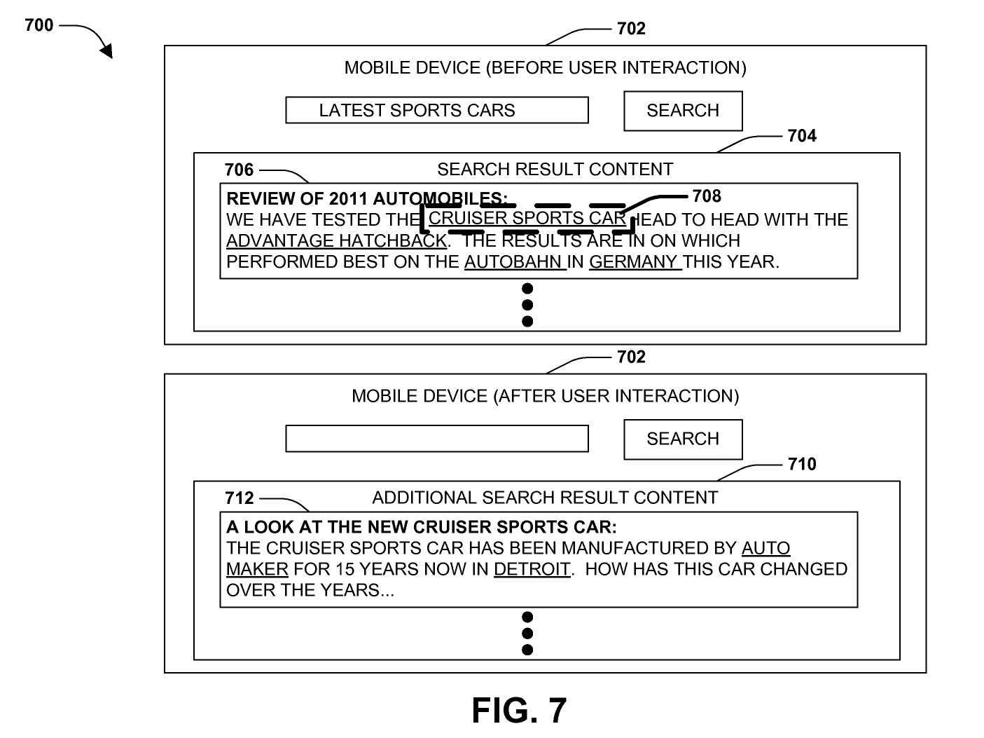

FIG. 7 illustrates an example 700 of search result content 704 with embedded user experience data before user interaction and additional search result content 710 after user interaction. A user may utilize a mobile device 702 to interact with a searching website. The user may, for example, submit a query “latest sports cars” to the searching website. Based upon the query “latest sports cars”, search result content 704 with embedded user experience data may be generated and/or presented to the user. The search result content 704 may comprise hyperlinks (user experience data) embedded with tagged terms (e.g., a first tagged term “Cruiser Sports Car” 708) of a first website link and description 706. It may be appreciated that the mobile device (before user interaction) represents the state of the mobile device 702 and/or search result content 704 before the user interacts with user experience data (e.g., a hyperlink embedded within the first tagged term “Cruiser Sports Car” 708) embedded within the search result content 704. It may be appreciated that the mobile device 702 comprises embedded hyperlinks (minimalistic user experience data) as user experience data because of the hardware limitations of the mobile device 702.

In one example, the hyperlink embedded within the first tagged term “Cruiser Sports Car” 708 may relate to a full search query on Cruiser Sports Cars. The user may invoke the hyperlink to initiate the full search query (user interaction). In response to receiving the user interaction with the hyperlink, additional data may be retrieved, tagged, embedded with new user experience data, and/or presented to the user within the mobile device (after user interaction) as the additional search result content 710. For example, the additional search result content 710 may comprise a second website link and description 712 with embedded user experience data (e.g., hyperlinks embedded within tagged terms “auto maker” and/or “Detroit”). In this way, the user is presented with results of a full search query based upon user interaction with embedded user experience data.

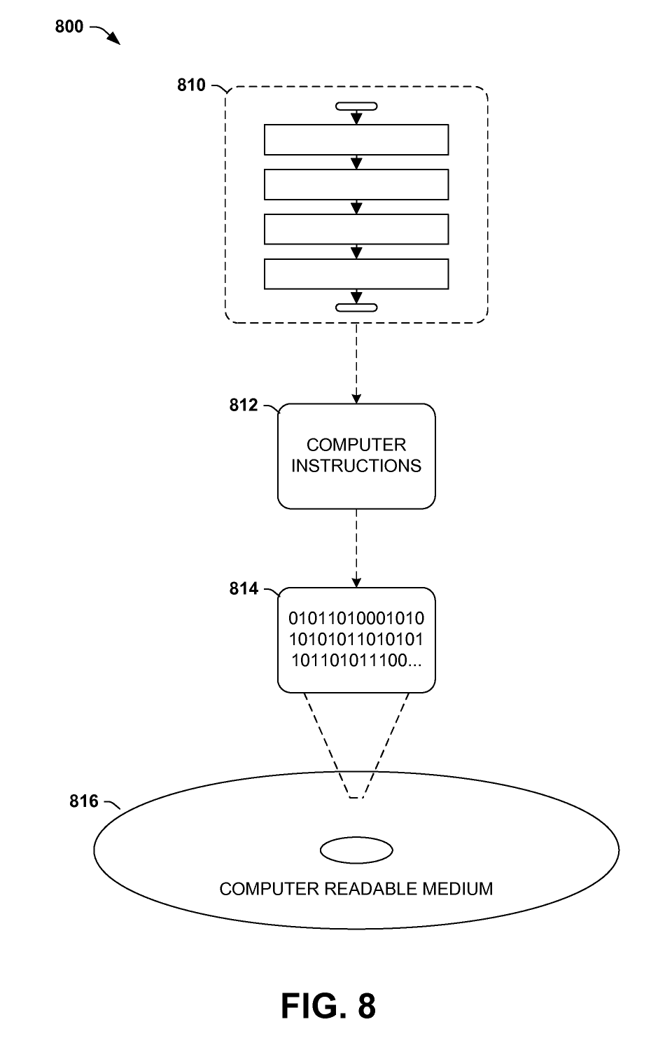

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable instructions 812 may be configured to perform a method 810, such as the exemplary method 100 of FIG. 1, for example. In another such embodiment, the processor-executable instructions 812 may be configured to implement a system, such as the exemplary system 200 of FIG. 2 and the exemplary system 300 of FIG. 3, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

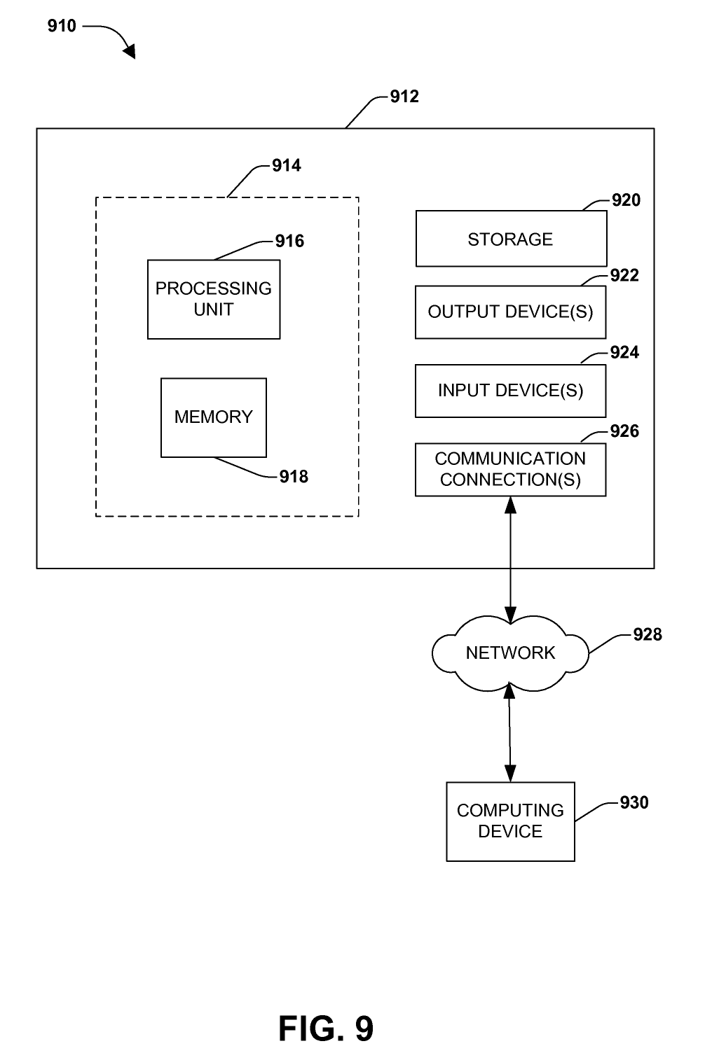

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for embedding user experience data in search result content executed via a processor on a computer having a memory whereon computer executable instructions comprising the method are stored, comprising:
receiving search result content of a user search query;
tagging one or more terms within the search result content based upon a user intent;
embedding user experience data within respective tagged terms; and
presenting the search result content to a user.

2. The method of claim 1, the embedding user experience data comprising:
embedding a link within a tagged term, the link comprising data relating to the tagged term as a pop-up.

3. The method of claim 1, the embedding user experience data comprising:
embedding a link within a tagged term, the link comprising data relating to the tagged term as a full search term query.

4. The method of claim 3, comprising:
retrieving from one or more backend servers additional user experience data based upon user interaction of the full search term query; and
presenting the additional user experience data to the user as new search result content.

5. The method of claim 1, the embedding user experience data comprising:
embedding a link within a tagged term, the link comprising data relating to the tagged term as a partial search term query.

6. The method of claim 5, comprising:
retrieving from one or more backend servers additional user experience data based upon user interaction of the partial search term query; and
presenting the additional user experience data to the user with the presented search result content without refreshing the presented search result content.

7. The method of claim 1, the tagging comprising:
determining the user intent based upon at least one of:
previous user search queries;
previous user search result content;
previous user interaction with user search result content; and
previous user selection of tagged terms within user search result content.

8. The method of claim 1, wherein the user experience data of a tagged term comprises at least one of:
a hyperlink associated with an additional search query suggestion related to the tagged term;
a hyperlink comprising adjunct call data related to the tagged term;
a pop-up comprising an image related to the tagged term; and
a pop-up comprising text related to the tagged term.

9. The method of claim 8, comprising:
selecting the user experience data based upon the type of device with which the user is engaged.

10. The method of claim 1, the tagging comprising:
determining a number of terms to tag based upon the type of device with which the user is engaged.

11. A system for embedding user experience data in search result content comprising:
a term tagging component configured to:
receive search result content of a user search query; and
tag one or more terms within the search result content based upon a user intent;
an embedding component configured to:
embed user experience data within respective tagged terms; and
a presentation component configured to:
present the search result content to a user.

12. The system of claim 11, comprising:
a user experience component configured to:
receive user interaction with embedded user experience data of a tagged term; and
retrieve additional data from one or more backend servers regarding the tagged term based upon the user interaction.

13. The system of claim 12, the term tagging component configured to:
tag one or more new terms within the additional data based upon a new user intent.

14. The system of claim 13, the embedding component configured to:
embed new user experience data within respective one or more new tagged terms.

15. The system of claim 14, the presentation component configured to:
present the additional data to the user through a pop-up or additional search result content.

16. The system of claim 11, the term tagging component configured to:
determine the user intent based upon at least one of:
previous user search queries;
previous user search result content;
previous user interaction with user search result content; and
previous user selection of tagged terms within user search result content.

17. The system of claim 11, the embedding component configured to:
embed a link within a tagged term, the link corresponding to pop-up data related to the tagged term.

18. The system of claim 11, the embedding component configured to:
embed a link within a tagged term, the link comprising metadata instructions of an adjunct call.

19. The system of claim 11, the embedding component configured to:
embed user experience data comprising at least one of:
a hyperlink associated with an additional search query suggestion;
a hyperlink comprising adjunct call data;
a pop-up comprising an image; and
a pop-up comprising text.

20. A non-transient computer readable storage medium comprising computer executable instructions that when executed on a computer via a microprocessor perform a method comprising:
receiving search result content of a user search query;
tagging one or more terms within the search result content based upon a user intent;
embedding user experience data within respective tagged terms as metadata of a webpage with which a user is engaged using a mobile device, the user experience data comprising at least one of:
a hyperlink associated with an additional search query suggestion;
a hyperlink comprising adjunct call data;
a pop-up comprising an image; and
a pop-up comprising text; and
presenting the webpage comprising the search result content to the user.
